(19) United States
(12) Patent Application Publication
(10) Pub. No.: US 2006/0148357 A1
(43) Pub. Date: Jul. 6, 2006

(54) Elastic laminate having topography

(76) Inventors: Stephen A. Baratian, Roswell, GA (US); Paul W. Estey, Cumming, GA (US); Mark Kupelian, Atlanta, GA (US); Mark B. Majors, Cumming, GA (US); Monica G. Varriale, Woodstock, GA (US); Howard M. Welch, Woodstock, GA (US)

Correspondence Address: KIMBERLY-CLARK WORLDWIDE, INC., 401 NORTH LAKE STREET, NEENAH, WI, 54956, US

(21) Appl. No.: 11/026,180

(22) Filed: Dec. 30, 2004

(51) Int. Cl. B32B 27/12; D04H 3/00; D04H 13/00

(52) U.S. Cl. 442/327; 442/397

(57) ABSTRACT

An elastic laminate having topographical features and a method of making an elastic laminate that includes topographical features is described. The elastic laminate includes a plurality of elastic strands made up of an elastomeric adhesive composition to provide topographical features that can withstand compression. In one particularly desirable embodiment the elastic laminate is treated so that the laminate is fluid permeable. Such laminates are useful as intake layers in personal care products, for example bodyside liners in diapers.

### BACKGROUND

Personal care absorbent articles, such as diapers, training pants, and adult incontinence garments typically include a liquid pervious top layer (often referred to as a bodyside liner or topsheet), a liquid impermeable bottom layer (often referred to as an outer cover), and an absorbent core between them. The absorbent core is often defined as including a front region (closer to the front waist of the wearer), a back region (closer to the rear waist of the wearer), and a crotch region (the lowermost region on a wearer, connecting the front region to the back region). For purposes of this document, the front region of the absorbent core may be defined as including one-third of the length of the absorbent core measured from the edge of the absorbent core which is closest to the front waist edge of the article. The back region of the absorbent core may be defined as including one-third of the length of the absorbent core measured from the edge of the absorbent core which is closest to the rear waist edge of the article. The crotch region of the absorbent core may be defined as including the remaining one-third of the length of the absorbent core which is bounded by the front region and the back region.

Conventional bodyside liner materials are liquid pervious layers constructed of a spunbonded layer of nonwoven hydrophobic fibers such as polypropylene spunbonded fibers. Bodyside liners are designed to provide a liquid pervious barrier between a wearer of a personal care absorbent article that includes the liner and any absorbent structures beneath the liner. With this in mind, it is known to provide bodyside liners which are liquid pervious and that do not retain liquids. Such liners merely act as a pass through or separation layer.

It is desirable that personal care absorbent articles, and especially garments such as diapers, training pants, or incontinence garments, without limitation referred to generically now for ease of explanation as “diapers,” provide a close, comfortable fit about body of the wearer and contain body exudates while maintaining skin health such as through breathability of the garment. At the same time many of the methods that may be commonly used to provide fit also keep the acquisition layer in close contact with the skin. A bodyside liner that provides topography and skin separation that also provides elasticity would be very desirable. In certain circumstances, it is also desirable that such garments are capable of being pulled up or down over the hips of the wearer to allow the wearer or care giver to easily pull the article on and easily remove the article.

The person having ordinary skill in the art of disposable diaper manufacture will appreciate that the disposable diaper is generally made up of the layers of a substantially liquid-impermeable backsheet or outer cover, a liquid-permeable topsheet or liner, and a liquid retention structure or absorbent core located between the backsheet and the liner. Often, these layers, especially with regard to the liners and outer covers, comprise a nonwoven which can economically be made extensible but which lacks sufficient retraction.

Great attention has particularly been applied to the so called “cuff areas” of the waist band and leg holes. However it is now considered optimal in some garment applications to have entire substrates, e.g. liners and outer covers, which have extensible and retractive abilities. Various schemes for producing elastic or retractive materials for disposable diapers have been proposed. Unfortunately, application of elastic or elastomeric materials to the nonwoven webs to gain elasticity is generally expensive. Use of less elastic material is desirable. Additionally, elastic materials may have various shortcomings including fluid barrier problems such as lack of liquid transmission or lack of vapor breathability, loss of good hand, drape, and appearance, difficulty in handling monolithic elastic elements, etc., when considered in light of certain garment layer applications, particularly liners and, in some instances, layers within an outer cover assembly.

Thus, there remains a need in the art to provide ease and economy of manufacture of retractive garment layers, especially where such garments are intended to be disposable.

Conventional liners provide only the function of separating the wearer from the absorbent while remaining fluid permeable. It would be desirable to provide a liner with additional functions, such as improved BM intake, improved fit and/or features capable or trapping solids and/or viscous fluids.

It would also be desirable to produce an elastic bodyside liner material that is elastic and liquid permeable and that readily allows aqueous fluids, particularly water, urine and other fluid wastes, to readily pass through the laminate in both the stretched and unstretched states.

### SUMMARY

The present invention provides a liquid permeable facing material that includes an elastic strand laminate, that includes a facing sheet having an exterior surface upon which are disposed a plurality of strands of an elastomeric composition forming features in the laminate in the relaxed state having a height that exceeds the thickness of the facing sheet of at least about 0.8 millimeter. In certain embodiments, the plurality of strands are spaced apart on the at least one facing sheet by 1 to 40 strands per centimeter. More desirably, the plurality of strands are spaced apart on the facing sheet by 5 to 30 strands per centimeter, more desirably, the plurality of strands are spaced apart on the facing sheet by 5 to 25 strands per centimeter and still more desirably, the plurality of strands are spaced apart on the facing sheet by 5 to 10 strands per centimeter. In certain embodiments, each of the plurality of strands has a diameter of at least about 0.2 millimeters. In certain embodiments, the facing sheet comprises a nonwoven web is a necked spunbond web or a crimped spunbond web. Desirably, the features of the laminate have an average height of at least 0.9 millimeters. More desirably, the features of the laminate have an average height of at least 1 millimeter. In certain embodiments, the average spacing between features ranges from about 0.5 millimeters to about 5 millimeters. In certain other embodiments, the average spacing between features ranges from about 0.5 millimeters to about 3 millimeters. The laminate may have a basis weight between about 30 and about 110 grams per square meter. Desirably, the facing material is extensible in the CD direction and can stretch by at least about 10 percent in the machine direction. More desirably, the facing material is extensible in the CD direction and can stretch by at least about 25 percent in the machine direction. And still more desirably, the facing material is extensible in the CD direction and can stretch by at least about 50 percent in the machine direction. In certain desirable embodiments, the facing material has a Fecal Fluid Intake rate of greater than 0.5 milliliters per second using the Fecal Fluid Intake Test and LVA1 Fecal Fluid Simulant. In a more desirable embodiment, the facing material has a Fecal Fluid Intake rate of greater than 0.6 milliliters per second using the Fecal Fluid Intake Test using LVA1 Fecal Fluid Simulant. In a still more desirable embodiment, the facing material has a Fecal Fluid Intake rate of greater than 0.7 milliliters per second using the Fecal Fluid Intake Test using LVA1 Fecal Fluid Simulant, more desirably greater than 0.8 milliliters per second and even more desirably greater than 0.9 milliliters per second. In certain desirable embodiments, the plurality of elastics strands provide elasticity in both the cross direction and the machine direction.

The liquid permeable of the present invention are particularly suitable as bodyside liners in personal care absorbent articles, particularly diapers, incontinence garments, training pants and so forth.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a plan view of one embodiment of an elastic laminate of the invention.

FIG. 2 is a cross-sectional view, taken along line 2-2 of FIG. 1, of an elastic laminate of the invention.

FIG. 3 illustrates a representative process for making the elastic laminates of the invention.

FIG. 4 is a schematic view of another process for making the elastic laminates of the invention.

FIG. 5 is a simplified plan view of a diaper.

FIG. 6 is an illustration of a side view of a laminate in a relaxed state.

FIG. 7 is an illustration of a side view of the laminate of FIG. 6 in an extended state.

### DEFINITIONS

As used herein the following terms have the specified meanings, unless the context demands a different meaning or a different meaning is expressed; also, the singular generally includes the plural, and the plural generally includes the singular unless otherwise indicated.

As used herein, all percentages, ratios and proportions are by weight unless otherwise specified.

“Bonded” refers to the joining, adhering, connecting, attaching, or the like, of at least two elements. Two or more elements will be considered to be bonded together when they are bonded directly to one another or indirectly to one another, such as when each is directly bonded to intermediate elements.

“Elastic tension” refers to the amount of force per unit width required to stretch an elastic material (or a selected zone thereof) to a given percent elongation.

“Elastomeric” and “elastic” are used interchangeably to refer to a material or composite that is generally capable of recovering its shape after deformation when the deforming force is removed. Specifically, as used herein, elastic or elastomeric is meant to be that property of any material which, upon application of a biasing force, permits the material to be stretchable to a stretched biased length which is at least about 50 percent greater than its relaxed unbiased length, and that will cause the material to recover at least 40 percent of its elongation upon release of the stretching force. A hypothetical example that would satisfy this definition of an elastomeric material would be a one (1) inch sample of a material which is elongatable to at least 1.50 inches and which, upon being elongated to 1.50 inches and released, will recover to a length of less than 1.30 inches. Many elastic materials may be stretched by much more than 50 percent of their relaxed length, and many of these will recover to substantially their original relaxed length upon release of the stretching force.

“Elongation” refers to the capability of an elastic material to be stretched a certain distance, such that greater elongation refers to an elastic material capable of being stretched a greater distance than an elastic material having lower elongation.

“Extendible” and “extensible” refer to a material which is stretchable in at least one direction but which may or may not have sufficient recovery to be considered elastic.

“Film” refers to a thermoplastic film made using a film extrusion process, such as a cast film or blown film extrusion process. The term includes apertured films, slit films, and other porous films which constitute liquid transfer films, as well as films which do not transfer liquid.

“Garment” includes personal care garments, medical garments, and so forth. The term “disposable garment” includes garments that are typically disposed of after 1-5 uses. The term “personal care garment” includes diapers, training pants, swimwear, absorbent underpants, adult incontinence products, feminine hygiene products, and so forth. The term “medical garment” includes medical (i.e., protective and/or surgical) gowns, caps, gloves, drapes, face masks, and so forth. The term “industrial workwear garment” includes laboratory coats, cover-alls, and so forth.

“High softening point tackifier” refers to a tackifier having a softening point above 80 degrees Celsius, and a viscosity of at least 1500 cps at 360 degrees Fahrenheit as measured by a ring and ball method (ASTM E-28).

“Hysteresis” as used herein refers to material recovery after stretch with zero percent being a perfect return or complete recovery of the retractive material while 100% loss would indicate that no recovery was made and hence the material tested is not retractive.

“Immediate set” as used herein refers to permanent plastic deformation of the material. For example a 10 cm piece of material when stretched to 15 cm and allowed to relax may return to only 12 cm, for a gain in length of 2 cm or a 20% immediate set.

“Layer” when used in the singular can have the dual meaning of a single element or a plurality of elements.

“Low softening point additive” refers to a tackifier, a wax or other low molecular weight polymers having a softening point below 80 degrees Celsius, and a viscosity of less than 1000 cps at 360 degrees Fahrenheit as measured by a ring and ball method (ASTM E-28).

“Machine direction”, or MD, refers to the length of a fabric in the direction in which it is produced. The term “cross machine direction” or CD means the width of fabric, i.e. a direction generally perpendicular to the MD. As described in the X, Y and Z axes, X will be MD, Y will be CD and Z will be depth or thickness of the material.

“Melt tank processable” refers to a composition that can be processed in conventional hot melt equipment rather than in an extruder. Hot melt equipment can be used online, such as in a diaper machine, whereas extruders are used offline due to equipment restrictions.

“Meltblown fiber” refers to fibers formed by extruding a molten thermoplastic material through a plurality of fine, usually circular, die capillaries as molten threads or filaments into converging high velocity gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface.

“Nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Softening point” refers to a material softening temperature, typically measured by a ring and ball type method, ASTM E-28.

“Spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as taught, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Strand” refers to an article of manufacture which may be thread-like with a cylindrical cross-section, for example, or may be flat or ribbon-like with a rectangular cross-section, for example.

“Stretch-to-stop” refers to a ratio determined from the difference between the unextended dimension of a composite elastic material and the maximum extended dimension of a composite elastic material upon the application of a specified tensioning force and dividing that difference by the unextended dimension of the composite elastic material. If the stretch-to-stop is expressed in percent, this ratio is multiplied by 100. For example, a composite elastic material having an unextended length of 12.7 cm (5 inches) and a maximum extended length of 25.4 cm (10 inches) upon applying a force of 2000 grams has a stretch-to-stop (at 2000 grams) of 100 percent. Stretch-to-stop may also be referred to as “maximum non-destructive elongation”.

“Thermoplastic” describes a material that softens and flows when exposed to heat and which substantially returns to a non-softened condition when cooled to room temperature.

“Vertical filament stretch-bonded laminate” or “VF SBL” refers to a stretch-bonded laminate made using a continuous vertical filament process, as described herein.

As used herein, the term “neck” or “neck stretch” interchangeably means that the fabric is extended under conditions reducing its width or its transverse dimension. The controlled extension may take place under cool temperatures, room temperature or greater temperatures and is limited to an increase in overall dimension in the direction being extended up to the elongation required to break the fabric. The necking process typically involves unwinding a sheet from a supply roll and passing it through a brake nip roll assembly driven at a given linear speed. A take-up roll or nip, operating at a linear speed higher than the brake nip roll, extends the fabric and generates the tension needed to elongate and neck the fabric. U.S. Pat. No. 4,965,122, to Morman, incorporated by reference in its entirety, discloses a process for providing a reversibly necked nonwoven material which may include necking the material, then heating the necked material, followed by cooling.

As used herein, the term “neckable material or layer” means any material which can be necked such as a nonwoven, woven, or knitted material. As used herein, the term “necked material” refers to any material which has been extended in at least one dimension, (e.g. lengthwise), reducing the transverse dimension, (e.g. width), such that when the extending force is removed, the material can be pulled back, or relax, to its original width. The necked material typically has a higher basis weight per unit area than the un-necked material. When the necked material returns to its original un-necked width, it should have about the same basis weight as the un-necked material. This differs from stretching/orienting a material layer, during which the layer is thinned and the basis weight is permanently reduced.

Typically, such necked nonwoven fabric materials are capable of being necked up to about 80 percent. For example, the neckable backsheet of the various aspects of the present invention may be provided by a material that has been necked from about 10 to about 80 percent, desirably from about 20 to about 60 percent, and more desirably from about 30 to about 50 percent for improved performance. For the purposes of the present disclosure, the term “percent necked” or “percent neckdown” refers to a ratio or percentage determined by measuring the difference between the pre-necked dimension and the necked dimension of a neckable material, and then dividing that difference by the pre-necked dimension of the neckable material and multiplying by 100 for percentage. The percentage of necking (percent neck) can be determined in accordance with the description in the above-mentioned U.S. Pat. No. 4,965,122.

These terms may be defined with additional language in the remaining portions of the specification.

### DETAILED DESCRIPTION OF THE PRESENTLY PREFERRED EMBODIMENTS

The present invention is directed to an elastic laminate having topographical features. By “topographical features”, we mean a gathered structure where the thickness of the final laminate in the relaxed state is at least 50 percent greater than the thickness of the combined ungathered components of the laminate as measured by a compressometer or by light microscopy. For example, the thickness of a laminate can be measured using a STARRET® Compressometer as described below. In a particularly desirable embodiment, the present invention provides an elastic laminate of a facing sheet and strands or other features that gather the facing sheet to provide topographical features. Exemplary facing sheets include various nonwoven materials described in more detail below. It is also desirable that the laminate remains permeable to aqueous fluids, such as urine, menses and so forth. In desirable embodiments, the present provides an elastic laminate that has topographical features, that is fluid permeable and that is elastic in both the cross and machine direction of the laminate. In certain embodiments, the laminate is extendable in at least one axis, preferably in the cross direction of the laminate, by 60 percent or more and recovers by 55 percent or more while maintaining fluid permeability. In other embodiments, the laminate is extendable by 100 percent or more and recovers by 95 percent or more while maintaining fluid permeability. Desirably, laminates of the present invention have permeabilities that range from about 700 to about 5000 Darcy and, more desirably, from about 1000 to about 4000 Darcy as determined by the permeability test method described below.

The present invention also provides methods of making such laminates and personal care products, for example diapers, that incorporate one or more laminates as a fluid permeable, intake material such as a body-side liner or cover stock. The laminate may be incorporated into other suitable articles, such as personal care garments, medical garments, and industrial workwear garments. More particularly, the elastic laminate may be suitable for use in diapers, training pants, swimwear, absorbent underpants, adult incontinence products, feminine hygiene products, protective medical gowns, surgical medical gowns, caps, gloves, drapes, facemasks, laboratory coats, coveralls and so forth.

Generally, an elastic laminate of the invention includes a plurality of topographical strands formed from an elastomeric composition. Advantageously, such strands provide topographical features that can withstand compressive forces. Desirably, the elastic strands are on at least one a surface of the laminate and have diameters or heights of at least about 0.2 mm to form topographical features of the laminate of at least 0.8 mm in height, desirably topographical features of at least 0.9 mm in height and, even more desirably, at least about 1 mm in height. That is, the topographic feature of the laminate have a height at least 0.8 or more millimeters greater than the thickness of the facing sheet. In the exemplary embodiments, the topographical features are formed by gathering. In certain embodiments, the present invention provides an elastic laminate has from 1 to 40 topographical features per centimeter (cm) in the machine direction (MD) of the laminate. In other embodiments, the laminate has at least 5 to 30 topographical features per cm in the MD, even more desirably, from about 5 to 25 topographical features per cm, and still even more desirably, from 5 to 10 topographical features per cm. Thus, the spacing between topographical features ranges from about 0.5 millimeters (mm) to about 5 mm, more desirably from about 0.5 to about 3 mm. In certain embodiments, the topographical features have average heights or amplitudes of at least 0.7 mm, more desirably at least about 0.8 mm, still more desirably at least about 0.9 mm and still even more desirably at least 1 mm ranging up to about 5 mm.

Generally, the elastomeric composition includes at least one base elastic polymer. It is also suggested that the elastomeric composition include a high softening point tackifier resin so that an adhesive is not necessary. However, the strands may be adhered to a facing sheet with the use of an adhesive. The composition may also include a low softening point additive and/or an antioxidant. The choice of polymer and tackifier should be considered, as is the ratio of polymer or copolymers to tackifier. Another consideration is the ratio of low softening point additive to high softening point tackifier.

In certain embodiments, the base polymer suitably has a styrene content of between about 15% and about 45%, or between about 18% and about 30%, by weight of the base polymer. The base polymer may achieve the styrene content either by blending different polymers having different styrene co-monomer levels or by including a single base polymer that has the desired styrene co-monomer level. Generally, the higher the styrene co-monomer level is, the higher the tension is. The base polymer may include polystyrene-polyethylene-polypropylene-polystyrene (SEPS) block copolymer, styrene-isoprene-styrene (SIS), styrene-butadiene-styrene (SBS) block copolymer, styrene ethylene butadiene styrene (SEBS) block copolymer, thermoplastic polyurethane, ethylene-propylene-diene (EPDM) copolymer, as well as combinations of any of these. One example of a suitable SEPS copolymer is available from KRATON Polymers of Houston, Tex. under the trade designation KRATON® G 2760. One example of a suitable SIS copolymer is available from Dexco, a division of Exxon-Mobil, under the trade designation VECTOR™. Suitably, the composition includes the base polymer in an amount between about 30% and about 75% by weight of the composition. It is suggested that the base polymer suitably has a Shore A hardness of between about 20 and about 90, more desirably between about 30 and about 80. Shore hardness is a measure of softness, and can be measured according to ASTM D-5. It is further suggested that the base polymer may have a melt flow rate between about 5 and about 200 grams per minute, Shore A hardness between about 20 and about 70, and may be stretched up to about 1300%.

The tackifier may include hydrocarbons from petroleum distillates, rosin, rosin esters, polyterpenes derived from wood, polyterpenes derived from synthetic chemicals, as well as combinations of any of these. In one embodiment, the composition from which the strands are made is a high softening point tackifier. An example of a suitable high softening point tackifier is available from Hercules Inc. of Wilmington, Del., under the trade designation PICOLYTE™ S115. Desirably, the composition includes the high softening point tackifier in an amount between about 30% and about 70% by weight of the composition.

A low softening point additive may be included in the compositions as well. A low softening point additive typically has a softening point below 80 degrees Celsius and a viscosity of less than 1000 cps at 360 degrees Fahrenheit, while a high softening point tackifier typically has a softening point above 80 degrees Celsius and a viscosity of at least 1500 cps at 360 degrees Fahrenheit. The use of predominantly high softening point tackifiers with high viscosity is important for adhesion improvement due to enhanced cohesive strength. However, the inclusion of relatively low amounts of low softening point additives provides instantaneous surface tackiness and pressure sensitive characteristics as well as reduced melt viscosity. Suitably, the low softening point additive is present in the composition in an amount between about 0% and about 20% by weight of the composition. One example of a particularly suitable low softening point additive is PICOLYTE™ S25 tackifier, available from Hercules Inc., having a softening point in a range around 25 degrees Celsius, or paraffin wax having a melting point of about 65 degrees Celsius may also be used.

Additionally, an antioxidant may be included in the composition, suitably in an amount between about 0.1% and about 1.0% by weight of the composition. One example of a suitable antioxidant is available from Ciba Specialty Chemicals under the trade designation IRGANOX™ 1010.

Viscosity of the formulated elastomeric adhesive composition is suitably in the range of 5,000 to 80,000 cps at 350 to 400 degrees Fahrenheit, or 10,000 to 50,000 cps at between 350 and 385 degrees Fahrenheit. The adhesive composition can be processed by conventional hot melt equipment. In certain embodiments, an adhesive is sprayed directly onto the sheet material to be bonded to the continuous filaments. However, other arrangements of adhesive application, such as brushing or the like, may also be utilized. In addition, the adhesive may be applied directly to the sheet material prior to bonding with the continuous filaments, may be applied to both the continuous filaments and the sheet material prior to bonding, or may be applied to one or both of the filaments and the sheet material while bonding pressure is being applied. The present invention is not limited to any particular bonding mechanism. Particular meltspray adhesives that may be utilized include Findley brand 2717, Findley-brand H2525A and Findley-brand H2096, all available from Findley Adhesives (known also as Bostik Findley). These adhesives may be applied through a hot melt spray die at an elevated temperature of approximately 300-375° F. to the inner surface of the facing. The meltspray adhesive usually will form a very lightweight layer of about 3 grams per square meter (“gsm”) of adhesive in the final composite. These particular Findley adhesives are elastic as well. The illustrated system employs nip rolls to apply pressure to the adhesive-coating facing and the continuous filaments to result in the necessary lamination. Alternatively, an adhesive is not required when tackified filaments are utilized to produce a laminate of the present invention. The outer facing is bonded together with the continuous filaments at a fairly high surface pressure, which may be between about 20 and 300 pounds per linear inch (“pli”). A typical bonding pressure may be about 50 pli or about 100 pli. Suggested adhesives are further described in U.S. patent application Ser. Nos. 10/750,925 and 11/011,439 both of which are hereby incorporated by reference herein.

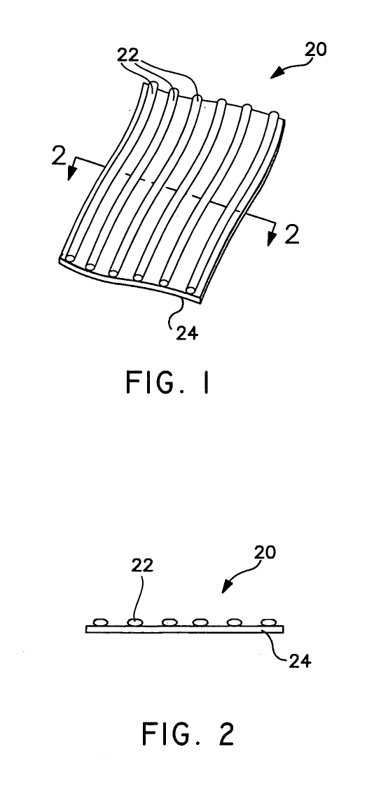

One embodiment of an elastic strand laminate 20 of the invention is shown in FIG. 1. The strands 22 may be self-adhered to a facing sheet 24. A cross-sectional view of the laminate 20 in FIG. 1 is shown in FIG. 2. It will be appreciated that the strands 22 may be laid out periodically, non-periodically, and in various spacings, groupings, and sizes, according to the effect desired from the elastic strand laminate 20 and the use to which it is put. For example, the strands 22 may be spaced apart to between about 4 and about 15 strands per inch. In desirable embodiments, the strands 22 are spaced apart on the facing sheet at about every 0.20 inches at about 5 strands per inch or about every 0.25 inches at about 4 strands per inch. Additionally, the strands may be laid out in various patterns other that that illustrated. For example, in one embodiment, the strands are disposed on a surface of a facing sheet in a zigzag pattern to provide the laminate with biaxial stretch and recovery. The filaments may be placed on the surface of the facing sheet by using a grooved steel roll to lay the filaments on the sheet in the desired pattern. The opposing roll of the nip may or may not have an additional pattern to assist in laminating the facing sheet to the patterned elongated elastic strands. In several embodiments, the strands 22 are substantially continuous in length. In the embodiment illustrated in FIG. 1, the strands 22 have a circular cross-section, but the strands may alternatively have other cross-sectional geometries such as elliptical as shown in FIG. 2, rectangular as in ribbon-like strands, triangular or multi-lobal. Each strand 22 suitably has a diameter between about 0.2 and about 2 mm, with “diameter” being the widest cross-sectional dimension of the strand. More desirably, each strand 22 has a diameter between about 0.5 and about 2 mm.

The strands 22 made of the elastomeric adhesive composition are capable not only of introducing a degree of elasticity to facing material 24 but are also capable of providing a topographical function on the surface of the facing material. Thus, it is desirable that the finished laminate in its relaxed state has undulations formed from the gathers created by the elastic strands. It is desirable that the relaxed laminate have a thickness at least 25% greater than the combined thickness of the flat individual components of the laminate, more desirably 50% greater and still more desirably 100% greater. It is suggested that such topographical features may provide better handling of fecal matter, particularly substantially fluid fecal matter as from runny bowel movements. It is also suggested that such topographical features may trap, hold or capture small particles that may be contained in runny bowel movements. These features are desirable for diapers, particularly diapers for newborns.

Facing material 24 may be a nonwoven web, a polymer film or a laminate formed using conventional processes, including the spunbond and meltblowing processes described in the DEFINITIONS. In several embodiments, facing material is a nonwoven web formed by a spunbond process. For example, in certain embodiments, the facing sheet 24 is a spunbonded web having a basis weight of about 0.1-4.0 ounces per square yard (osy), suitably 0.2-2.0 osy, or about 0.4-0.6 osy. The laminate 20 suitably has a basis weight between about 20 and about 120 grams per square meter.

If the facing sheet 24 is to be applied to the strands 22 without first being stretched, the facing sheets may or may not be capable of being stretched in at least one direction in order to produce an elasticized area. For example, the facing sheets could be necked, or gathered, in order to allow them to be stretched after application of the strands. Suggested degrees of necking range from about 10% to about 80%. More preferably, suggested degrees of necking range from about 20 to about 60 percent and even more preferably from about 30% to about 50%. In at least one exemplary embodiment, the facing sheet was necked by 35 percent. Various post treatments, such as treatment with grooved rolls, which alter the mechanical properties of the material, are also suitable for use. It is possible that the strands do not constrict upon cooling but, instead, tend to retract to approximately their original dimension after being elongated during use in a product.

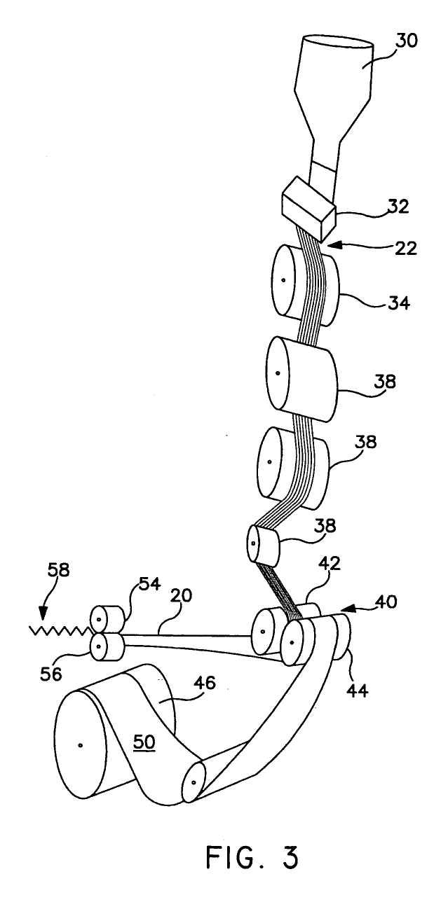

FIG. 3 illustrates a method and apparatus for making an elastic strand laminate 20 of the invention. While FIG. 3 illustrates a composite vertical filament (VF) stretch bonded laminate (SBL) process it will be appreciated that other processes consistent with the present invention may be used. The elastomeric adhesive composition is formulated by mixing the base polymer and the tackifier in a Sigma blade batch mixer or by other suitable compounding methods including continuous mixing processes such as twin screw extrusion, resulting in a solid phase composition. Conventional hot melt equipment can be used to heat the composition. For example, solid blocks of the composition may be heated in a melt tank 30 at about 385 degrees Fahrenheit, for example, to form a liquid phase, and then processed through a strand die 32 at between about 20 and about 150 grams per square meter (gsm), or between about 40 and about 100 gsm output before stretching, onto a first chill roll 34 or similar device at between about 10 and about 55 degrees Celsius, for example, in the form of multiple strands 22. Strand output (gsm) denotes grams per square meter as measured by cutting the strands with a template and weighing them. The strands 22 are then stretched (between about 200% and about 1200%) and thinned as the strands are peeled off the first chill roll 34 and passed to one or more fly rollers 38 towards a nip 40. The strands 22 may be stretched down to a narrower width and thinned by the fly rollers 38 during their passage to the nip 40. The nip 40 is formed by opposing first and second nip rollers 42, 44. It is suggested any rolls or rollers are coated with a non-stick treatment, preferably a high release coating. One suggested non-stick treatment for steel rolls and rollers is plasma coating PC60301-4004F from Impreglon of Fairbum, Ga. A suggested non-stick treatment for rubber rolls and rollers is Shore 60 A SILFLEX silicone rubber from Stowe-Woodward of Griffon, Ga.

The configuration of the strand die 32 determines the number of strands, diameter of the strands, spacing between the strands, as well as shape of the strands. The elastomeric adhesive composition in the form of strands 22 suitably has an elongation of at least 50 percent, alternatively of at least 150 percent, alternatively of from about 50 percent to about 500 percent, and a tension force of less than about 400 grams force per inch (2.54 cm) width, alternatively of less than about 275 grams force per inch (2.54 cm) width, alternatively of from about 100 grams force per inch (2.54 cm) width to about 250 grams force per inch (2.54 cm) width. Tension force, as used herein, is determined one minute after stretching the elastic strand laminate to 100% elongation.

In order to form the elastic strand laminate 20, roll 46 of spunbond facing material 50 or other nonwoven or film is fed into the nip 40 on a side of the strands 22 and is, preferably, bonded by the adhesive present in the strands 22. The facing material 50 may also be made in situ rather than unrolled from previously made rolls of material. The elastic strand laminate 20 can be maintained in a stretched condition by a pair of tensioning rollers 54, 56 downstream of the nip 40 and then relaxed as at reference number 58 as illustrate in FIG. 3.

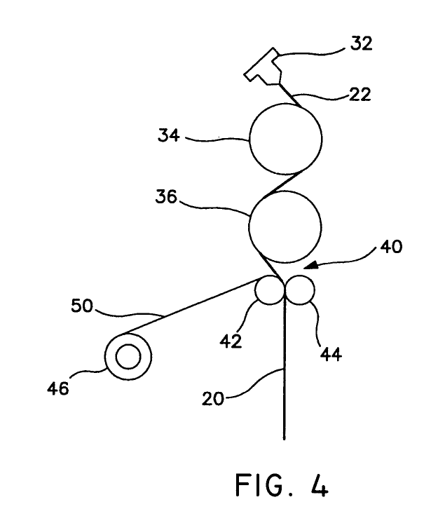

FIG. 4 illustrates a vertical lamination process in which no fly rollers 38 are used. Instead, the elastomeric adhesive composition in the form of strands 22 is extruded onto chill roller 34. The strands are stretched between chill rollers 34 and 36 and the nip 40. Except for the lack of fly rollers, the processes of FIGS. 3 and 4 are similar. In either case, the strands 22 can be laminated onto a surface of a facing layer 50 at the nip 40.

Tension within the laminate 20 may be controlled through varying the percentage stretch, or stretch ratio, of the strands 22 prior to adhesion to the facing sheet(s), and/or through the amount of strand add-on or thickness, with greater stretch and greater add-on or thickness each resulting in higher tension. Tension can also be controlled through selection of the elastomeric adhesive composition, and/or by varying strand geometries and/or spacing between strands. For example, holes in the strand die 32 through which the composition passes to form strands may vary in diameter. The laminate of the invention suitably has tension of at least 100 grams/inch at 100% elongation, or at least 200 grams/inch at 100% elongation.

To improve the wettability and/or aqueous fluid intake of the laminate, it is suggested that the laminate is surface treated with or otherwise includes one or more additives for improving wettability. Suggested additives and methods of treating additives are described in U.S. Patent Application Publication no. 2004/0121680 to Yahiaoui et al. which is hereby incorporated by reference herein. Other suggested wetness additive treatments are described in U.S. Pat. Nos. 6,017,832, 6,204,208 and 6,767,508 which are also incorporated by reference herein. One particularly suggested surface treatment is a mixture of additives that includes a solution of both AHCOVEL and GLUCOPON combined in a 3:1 ratio. Other suggested surface treatments include, but are not limited to, mixture of additives that includes a solution of AHCOVEL, GLUCOPON and MASIL SF-19 combined in a 3:1:1 ratio and AHCOVEL, GLUCOPON and MASIL SF-19 combined in a 6:1:3 ratio. Other suggested treatments and methods of treating substrates to improve wettability are described in U.S. Patent Application Publication nos. 2004/0122389, 2004/0009725, 2002/0069988, and 2002/0058056. Additionally, the laminate of the present invention may include or be treated to include additional chemistries, including but not limited to ointments, petrolatum, botanical agents and so forth to provide skin health benefits to the laminate.

In one desirable embodiment, the laminate, the facing or the strands include one or more internal wetting agents or is surface treated to improve wettability of the spunbond facing layer and of the overall composite elastic laminate. Suggested wetting agents include, but are not limited to, modified castor oils, hydrogenated ethoxylated castor oils, sorbitan monooleate, alkyl polyglycosides and so forth including mixtures of wetting agents. Suggested commercially available wetting agents include, but are not limited to, AHCOVEL and MASIL SF-19. Other suggested agents that can be used to improve the wettability of the composite or any of the layers of the composite include, but are not limited to, the siloxanes described in U.S. Pat. No. 5,336,707 to Nohr et al. which may be included in the melted thermoplastic compositions use to make any portion of the layers of the composite.

In another embodiment, a laminate of the present invention is surface treated with one or more surfactants to improve the wettability of the laminate. One suggested surfactant that can be used to surface treat a nonwoven of the present invention is a surfactant mixture that contains a mixture of both AHCOVEL Base N-62 and GLUCOPON 220 UP surfactant in a 3:1 ratio based on a total weight of the surfactant mixture. AHCOVEL Base N-62 can be obtained from Uniqema Inc., a business having offices in New Castle, Del., and includes a blend of hydrogenated ethoxylated castor oil and sorbitan monooleate. GLUCOPON 220 UP can be obtained from Cognis Corporation, a business having offices in Ambler, Pa., and includes alkyl polyglycoside. The surfactant may be applied by any conventional means, such as dip and squeeze, spraying, printing, brush, foam, coating or the like. The surfactant may be applied to the entire laminate or may be selectively applied to particular sections of the laminate, such as the medial section along the longitudinal centerline of a diaper or other personal care product, to provide greater wettability of such sections. Exemplary surface treatment compositions and methods of applying surface treatment compositions are described in U.S. Pat. Nos. 5,057,361; 5,683,610 and 6,028,016 which also are hereby incorporated by reference herein.

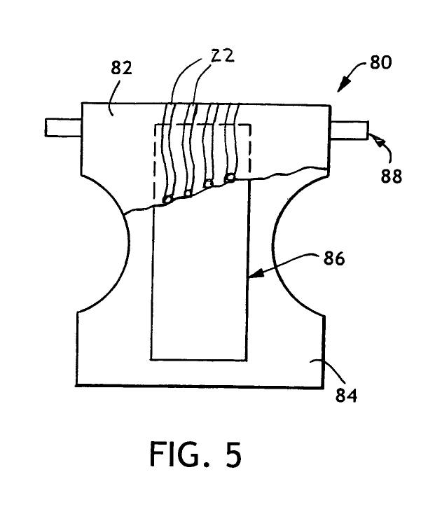

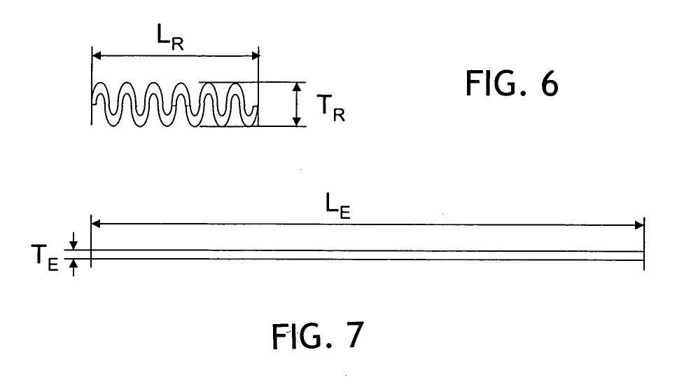

Fabrics of the present invention may be used in various personal care products, for example diapers. More specifically, the fabric of this invention may be used as a bodyside liner, core wrap or transfer layer in a diaper. A nonwoven fabric laminate of the present invention, for example the elastic laminate 20 illustrated and described with reference to FIGS. 1 and 2, may be used in a wide variety of applications, not the least of which includes personal care absorbent articles such as diapers, training pants, incontinence devices and feminine hygiene products such as sanitary napkins. An exemplary article 80, in this case a diaper, is shown generally in FIG. 5 of the drawings. Note that the strands 22 are not illustrated to scale and that the topographical features, for example gathers, are also not illustrated in FIG. 5 but are illustrated in FIG. 6. Other more complicated diaper constructions are known and are described and illustrated in detail in for example U.S. Pat. No. 5,520,673 to Yarbrough et al. and U.S. Pat. No. 6,217,890 to Paul et al., both of which are hereby incorporated by reference herein. Referring to FIG. 5 of the present invention, most such personal care absorbent articles 80 include a liquid permeable top sheet or liner 82, a back sheet or outercover 84 and an absorbent core 86 disposed between and contained by the top sheet 82 and back sheet 84. Articles 80 such as diapers may also include some type of fastening means 88 such as adhesive fastening tapes or mechanical hook and loop type fasteners.

Other specific examples of disposable diapers suitable for use in the present invention, and other components suitable for use therein, are disclosed in the following U.S. patents and U.S. patent applications: U.S. Pat. No. 4,798,603 issued Jan. 17, 1989, to Meyer et al.; U.S. Pat. No. 5,176,668 issued Jan. 5, 1993, to Bernardin; U.S. Pat. No. 5,176,672 issued Jan. 5, 1993, to Bruemmer et al.; U.S. Pat. No. 5,192,606 issued Mar. 9, 1993, to Proxmire et al.; U.S. Pat. No. 5,415,644 issued May 16, 1995, to Enloe; and U.S. Pat. No. 5,509,915 all of which are hereby incorporated herein by reference. Other suitable components include, for example, containment flaps and waist flaps. Specific examples of stretchable outercovers or backsheets that can be combined with liners, transfer layers and or core wraps of the present invention to produce a more stretchable diaper or other personal care article are described in U.S. Pat. No. 6,479,154 and U.S. patent application Ser. Nos. 10/703,761 and 10/918,553.

The resulting elastic laminate 20 is particularly useful in providing elastic intake layers or other elastic intake materials in personal care absorbent garments, such as the diaper shown in FIG. 5. More specifically, as shown in FIG. 5, the elastic strand laminate 20 is particularly suitable for use as a bodyside liner. The elastic laminates of the invention may be used as a bodyside liner and positioned with the topographical features, for example the strands 22, on the exterior of the diaper and facing toward the wearer or with the smooth side of the facing sheet that does not include the topographical strands 22 facing toward the wearer. Thus, in one embodiment, the present invention provides a diaper with an elastic bodyside liner having topographical features in which the topographical features are directed toward the interior of the diaper. The elastic laminate may be sealed to the diaper at the perimeter in a conventional manner as is known in the art.

### TEST METHODS

Cycle Testing

The materials were tested using a cyclical testing procedure to determine hysteresis and percent set. In particular, a 3 cycle testing was utilized to a 100 percent defined elongation. For this test, the sample size was 3 inches in the MD by 6 inches in the CD. The grip size was 3 inches in width. The initial grip separation was 4 inches. The samples were loaded such that the cross-direction of the sample was in the vertical, or cycling, direction. A preload tension of approximately 10-15 grams was set. The test pulled the sample at 20 inches/min (500 mm/min) to a 100 percent elongation, i.e., 4 inches in addition to the 4 inch gap, and then immediately without pause returned to the zero point, i.e., the 4 inch gauge separation. The test repeated the cycle for a sample up to 3 times. In-process testing (resulting in the data in this application) was done as a 3-cycle test. The results of the test data are all from the first and second cycles. The testing was done on a Sintech Corp. 2/S constant rate extension testing frame with an MTS RENEW controller using TESTWORKS 4.07b software from MTS Systems Corporation of Eden Prairie, Minn. The tests were conducted under ambient temperature and humidity room conditions. Intermediate set was determined from the length of the sample on the return or down cycle when the sample had reached zero tension.

Preparation of Synthetic Fecal Fluid

In order to develop a successful fecal fluid simulant, the resultant fecal fluid simulant should have key properties similar to those of the real fecal fluid. But the real biological fecal fluids have huge inherent variations. The feces of infants vary substantially depending on the type of food and among infants. The infants on formula produce feces of much higher viscosity than the infants on mother's breast milk. To obtain the BM properties of runny BM, a number of infants on breast milk were recruited. Their feces were colleted with a special diaper with a BM collection bag. The collected samples were tested for their viscosity, liner penetration rates and other properties.

A. Determination of the Fecal Fluid Property Targets:

1. Separation of Infant BM

In order to determine the target for fecal fluid simulant, it was important to separate the fecal fluid from the collected BM samples and then the properties of fecal fluid can be determined. To accomplish this, a centrifuge separation method was used. This method worked well. It resulted in two fractions, a solid fraction and a fecal fluid fraction. The fecal fluid fraction was collected and subjected to the analysis of chemical compositions and testing of its interaction with superabsorbent. A total of nineteen fecal fluid samples were collected in a six-week period.

2. Composition of Fecal Fluid

Nineteen collected fecal fluid samples were frozen and analyzed for composition. Samples of several whole BM samples were also analyzed for internal control. The following results were found:

Protein: Average, 1.99%; Standard Deviation: 0.44%; Range, 1.48 to 2.83%

Carbohydrates: Average, 6.84%; Standard Deviation, 2.11%; Range, 4.7 to 11.3%

Fat: Average, 0.11%; Standard Deviation, 0.21%; Range, 0.01 to 11.3%

Water: Average, 90.82%; Standard Deviation, 2.3%; Range, 85.84 to 93.48%

The compositional data were used to determine the effects of these fecal fluid components on the absorbency of superabsorbents and develop a fecal fluid simulant.

3. Absorbency of Collected Fecal Fluid

The absorbency of fecal fluid was determined using the fecal fluid absorbency under load (AUL) method at 0.3 psi, described below. The fecal fluid samples did not contain any particles but have dissolved proteins, carbohydrates, and a very small amount of fat. The viscosity of the collected fecal fluid is under 1 poise.

The screen porosity of the AUL calendar was found to be important to obtain reproducible results. The 100-mesh screen was found to be effective. A 400-mesh screen was found to be too fine for obtaining reproducible results partly caused by the increased resistance to the transport of fecal fluid through the small pores on the screen.

Fourteen collected fecal fluid samples were tested for 0.3 psi AUL. A Stockhausen superabsorbent (FAVOR 880) was used in the test. The average value of AUL for all the samples was 9.6 g/g (the viscosity of all the BM samples range from 1.4 to 109.9 poise).

The fecal fluid samples were also grouped according to the viscosity of whole BM prior to separation. The low viscosity (20 poise or less) fecal fluid had an average 0.3 psi AUL value of 13.4 g/g for FAVOR 880 while medium to high viscosity (20 to 109.9 poise) fecal fluid had an average of 0.3 psi AUL of 6.7 g/g. Therefore, there is a correlation between the fecal fluid AUL value and the original viscosity of whole BM. This is probably caused by the difference in the soluble material content in the samples. The high viscosity samples had a high level of dissolved proteins, carbohydrates, etc. These dissolved components also contribute to the depression of AUL by fecal fluid. This was illustrated by the component effect data disclosed in the next section.

With these determined targets, it was possible to proceed to the next step in the invention of a fecal fluid simulant.

B. Determination of the Effect of Fecal Fluid Components on the Absorbency

In order to develop a fecal fluid simulant, it was important to determine the quantitative effect of the individual component on the absorbency.

1. Effect of Protein

The proteins from both natural and synthetic origins can be used. An example of natural protein is egg white. Egg white can be separated into two fractions: a thin egg white fraction of low molecular weight and low viscosity, and thick egg white fraction of high viscosity and containing mucin.

Synthetic proteins prepared by polymerization of a variety of amino acids using protein synthesizer (employing Meerifiled's peptide synthesis process) can be utilized. The synthetic proteins have precise chemical composition and amino acid sequence but they are costly to make and less available.

For this invention, various egg components were separated and used as model compounds for protein. The egg components had the advantages of being biologically produced, low cost and safe to use.

The 0.3 psi fecal fluid AUL of pure egg components were determined to be as follows:

Thin egg white: 4.3 g/g

Thick egg white: 3.2 g/g

Egg yolk: 4.1 g/g

To determine the effect of egg protein on AUL, a series of solutions containing proteins were made. These solutions had egg protein concentrations in the range of protein content in the collected infant fecal fluids. Three concentration levels were selected: 1.4% (representing the low end of protein content of collected fecal fluids); 2.3% (representing the average of the protein content of collected fecal fluids), and 3.0% (representing the high end of the protein concentration of collected fecal fluids).

The solutions were based on 0.9% saline. Since egg whites contain water, an egg protein solution of certain protein concentration and salt concentration was needed.

The proper concentration was determined by first determining the water content of egg component using a moisture analyzer. The water content was then translated into the protein content in each egg component. The water in the egg component was taken into consideration when egg protein was added to the solution. The water in egg will cause a dilution in sodium chloride content. Additional sodium chloride was added to the solution based on the compositional calculation to obtain a composition of base ingredients going into the solution.

The effect of thin egg white protein on the absorbency of FAVOR 880 was determined. Thin egg white contains low molecular weight protein. It does not contain the high viscosity mucin. The FAUZL (free absorbency under zero load) decreased slightly with the increasing thin egg white protein. The fecal fluid AUL at 0.3 psi decreased substantially with increasing egg white protein, from 28.5 to 13.6 g/g.

The effect of thick egg white protein on both the FAUZL and AUL was determined. Thick egg white contains the high viscosity mucin component. The thick egg white decreased the fecal fluid AUL values more severely than the thin egg white at the same protein concentration. The relationship was used in developing the fecal fluid simulant.

2. Effect of Carbohydrates on the Absorbency

The effect of carbohydrates on fecal fluid AUL and FAUZL was determined by making testing fluid containing model carbohydrates. All the experiments were performed in 0.9% saline. There was little effect on absorbency resulting from carbohydrates.

The effect of sucrose (formed from two glucose units) on fecal fluid AUL and FAUZL was determined. The effect of this carbohydrate on both FAUZL and fecal fluid AUL was minimal. The effect of corn syrup on absorbency was determined. The effect was also negligible on both fecal fluid AUL and FAUZL.

Among the carbohydrates studied, the only carbohydrate having a substantial effect on the absorbency was dextran. Dextran is a bacterially produced polysaccharide from sucrose. It has different molecular weights depending on the bacteria strains and conditions of collected fecal fluid. It was found that the FAUZL was reduced from 36.2 g/g for FAVOR 880 in saline to 25.8 g/g at 12% concentration (the high end of determined carbohydrates in fecal fluid). The fecal fluid AUL was decreased from 28.5 g/g for saline to 19.1 g/g for 12% dextran solution.

3. Effect of Fat on Absorbency

When emulsified corn oil (used as a fat simulant) was added to the saline solution, it was found that the fat had little effect on either fecal fluid values.

C. Fecal Fluid Simulant Formulations

Based on the above relationship between the fecal fluid component and the determined absorbency, a series of formulation experiments were performed to develop a viable fecal fluid simulant with properties similar to the “real” biologically produced fecal fluid.

The fecal fluid AUL of saline, low viscosity fecal fluid, medium to high viscosity fecal fluid, and various egg components were determined. The real fecal fluid had AUL values between those of 0.9% saline and the egg components.

A series of formulations were designed based on calculation of the fecal fluid component effect at different concentrations. It was found that both natural and synthetic carbohydrates can be used. Low molecular weight carbohydrates, carbohydrate oligomers, and high molecular weight carbohydrates can be used in the formulation of the fecal fluid simulant.

4. Embodiments of Fecal Fluid Simulants

The fecal fluid simulants comprise proteins, carbohydrates, salt and water. Proteins from various origins and different preparation methods can be used for this invention. Proteins separated from eggs such as thin egg white, thick egg white, egg yolk, mixtures of egg white and yolk, and plasma separated from human blood or animal blood can be used as the protein component in the fecal fluid simulants. The range of protein ranges from 0.1 percent to 10% by weight of the simulant.

Various carbohydrates can also be used in the formulations. The amount of carbohydrates range from 0.1 to 15% by weight. The preferred carbohydrate is dextran.

Salts of monovalent, divalent and multi-valent metal ions and inorganic anions can be used in this invention. Examples of metal ions are sodium, potassium, lithium, magnesium, calcium ions, etc. Examples of inorganic anions are chloride, bromide, fluorides, sulfate, sulfonate, phosphate, carbonate, etc. The amount of the salt level can be adjusted to the average level of salt found in the fecal fluids.

The fecal fluid simulant formulation can be based on either saline or distilled water. In the case of distilled water, additional salts are used to adjust the ionic strength of real fecal fluid.

The resulting fecal fluid is homogeneous without any observable phase separation. The resulting fecal fluid is typically has a light yellow color.

The stability of the fecal fluid simulant can be substantially increased by adding preservatives.

Example of Simulant

In a 1 liter PYREX glass beaker, 128.5 grams of a 0.90% (w/w/) weight percent aqueous solution of sodium chloride supplied by RICCA® Chemical Company, Arlington, Tex., (10 L bag) was added. A magnetic stirrer was placed in the beaker and set on a magnetic stirring plate (Nuova II Stir Plate, Thermolyne Corporation, a subsidiary of Sybron Corporation, Dubuque, Iowa) on medium high speed (Level 7), 0.45 grams of sodium chloride (supplied by Aldrich Chemical Company, Milwaukee, Wis.) was added to the same beaker. After the sodium chloride completely dissolved, 0.72 grams of dextran (supplied by SIGMA® Chemical Company, St. Louis, Mo.) was subsequently added to the solution. After the dextran completely dissolved, 50 grams of thin egg white was added to the solution (separated from eggs by first removing the egg yolk and then filtering the egg through a 1700-micron filter made by American Scientific Products, McGaw Park, Ill.). Once all the thin egg white was added, the solution was mixed for 20 minutes. At the end of the mixing process, the beaker was removed from the magnetic stirring plate. Some of the egg particles coagulated to form pliable, stringy or clumpy, solid white masses on the center surface of the solution. The masses were removed using a disposable metal tweezers. The process produced a visually homogeneous liquid that is a pale, golden-yellowish in color.

AUL testing was performed by placing approximately 0.160 grams of a superabsorbent FAVOR 880 from Stockhausen in an AUL cylinder with a 100-mesh screen under a pressure of 0.3 psi. The cylinder was then set directly into the test fluid. Weight gains of the superabsorbent at different times were measured by removing the cylinder from the fluid and blotting away the excess fluid with a towel.

The following fecal fluid AUL result was obtained based on the average values of two repetitions using the simulant made in this example (Low Viscosity Average 1:LVA1): Absorbency under load at 0.3 psi: 13.1 g/g.

The targeted average absorbency for real, low viscosity fecal fluid: Absorbency under load at 0.3 psi: 13.4 g/g (range: 11.2-17.2 g/g).

Test Procedures for Fecal Fluid Intake Test and the Fecal Fluid Flowback Test Using LVA1 Fecal Fluid Simulant

1. Test Method:

1.1 This procedure describes the testing method used for both the Fecal Fluid Intake test and the Fecal Fluid Flowback test using LVA1 Fecal Fluid Simulant on a control absorbent core system.

2. Apparatus:

2.1. Plastic fluid intake and flowback evaluation (FIFE) device: 3 inch diameter circle and 3/16 inch thick Plexiglas base, a tube of 3 inch in height, 1 inch in inner diameter, and 1/16 inch in thickness Plexiglas tube is attached to the center of the base.

2.2. Mettler Toledo Scale-Model PR503 Delta Range-max 510 g, d=0.01 g/0.001 g

2.3. Plastic Petri dish approximately 3±2 inches in diameter

2.4. Four 50 gram weights (Plexiglas disks with 1.25″ diameter hole)

2.5. 50 milliliter graduated cylinder

2.6. 1294.51 gram weight

3. Materials and Supplies:

3.1. LVA1 Fecal Fluid Simulant

3.2. An absorbent core (basis weight: 677 gsm; composition: 5842% of FAVOR 880 superabsorbent from Degussa (Greensboro, N.C.) and 58% of CR1654 fluff from Bowater (Greenville, S.C.); density: 0.20 g/cc) cut into 3 inch diameter circles

3.3. Spunbond liner material cut into 3 inch diameter circles

3.4. 2.25 osy BCW (bonded carded web) surge material cut into 3 inch diameter circles

3.5. Blotter Paper cut into 3 inch diameter circles

4. Procedure:

4.1. Absorbent Core System Preparation
4.1.1. An absorbent core is layered below a 2.25 osy BCW surge material. A layer of spunbond liner is placed on top of the surge material layer.
4.1.2. Die cut the layered material into 3 inch diameter circles. The surge material and the spunbond liner should cover the entire top surface of the core.
4.1.3. Once the core system has been die cut, they should be compacted using a press. A gap of approximately 1.5 centimeters should be set between the rollers on the press before the layered core is run between them. The end result should be a layered core system that has been compacted to a density of 5.2 mm (Use bulk tester to check).

4.2. Fecal Fluid Intake Test and Fecal Fluid Flowback Test Setup
4.2.1. Place the core system into a plastic Petri dish (Approximately 3½ inches in diameter), and cover the core system with the plastic FIFE device.
4.2.2. When the device is centered atop of the core place four 50 gram Plexiglas disks on top of the device. The Plexiglas disks will evenly distribute the weight.
4.2.3. Measure twenty milliliters of LVA1 Fecal Fluid Simulant into a 50 milliliter graduated cylinder.

4.3. Fecal Fluid Intake Test
4.3.1. Pour the 20 milliliters of simulant into the center of the FIFE device onto the core. Pour the simulant at a constant rate and do not allow any simulant to run down the sides of the device so the results are not skewed.
4.3.2. Start a timer at the exact moment the simulant hits the layered core material.
4.3.3. When all 20 milliliters is poured into the FIFE device observe how long it takes for the fluid to become absorbed by the core system.
4.3.4. When the simulant level becomes low in the tube there will be a little ring of fluid left around the edge of the center part of the device. At the moment the little ring of fluid is absorbed record the time in seconds, which have passed since the timer was first started. DO NOT STOP THE TIMER.
4.3.5. Note: The intake rate for the control core system has been approximately 0.36 cc/sec in the past. If the intake rate is significantly different from this run a few more core systems through the press increasing or decreasing the gap between the rollers until a core is produced that absorbs the LVA1 Fecal Fluid Simulant at the proper rate.

4.4. Fecal Fluid Flowback Test
4.4.1. Place six pieces of blotter paper cut to 3 inches in diameter on the digital scale and record the weight.
4.4.2. Next wait until fifteen minutes has passed when the timer was first started during the FIFE portion of the test.
4.4.3. At the fifteen minute mark remove the four 50 gram disks and the FIFE device from the top of the core system. Place the six pieces of blotter paper on top of the core system.
4.4.4. Place a 50 gram disk on top of the blotter paper. Then place the 1294.51 gram weight on top of the 50 gram disk. The total weight on top of the FIFE device above the core system should measure approximately 0.6 psi.
4.4.5. After three minutes has passed with the 0.6 psi weight atop of the FIFE device remove the weights along with the FIFE device.
4.4.6. Weigh and record the weight of the six pieces of blotter paper.
   4.4.7. Subtract the weight of the blotter paper recorded before the flowback portion of the test from the weight of the blotter paper after the test has been completed. This will give the amount of fecal fluid flowback in grams. The average of the fecal fluid flowback values is reported.
   Air Permeability Testing

Air permeability was measured in cubic feet per minute by ASTM D 737-96 at 125 Pascals.

Caliper (Compressometer)

Material caliper or thickness of the examples was also measured. The caliper of an example material was determined by measuring the thickness of the example material (web) under a 0.05 psi (3,450 dynes/cm²) load using a STARRET®-type bulk tester. The thicknesses of the examples were measured and recorded in units of millimeters. Samples of material were cut into 4 inch by 4 inch (10.2 cm by 10.2 cm) or greater squares. Five samples were cut and measured under. The average thickness was used to provide a mean thickness for each example.

Macroscale Surface Feature Measurements

Cut 5 samples of laminate (or material) to 4 inch wide by 7 inch length relaxed. Measure and mark lengths L_{R} (one cm) along the MD of each sample, using a fine point marker and a ruler. Record the caliper of each sample (to the nearest 0.01 mm) and obtain an average thickness T_{R}. Fully extend each sample and record the caliper of each obtaining an extended thickness T_{E}. While the sample is fully extended measure and record the length (to the nearest mm) of the mark in the extended state L_{E}. The average amplitude A of the features cannot exceed T_{R}−T_{F}. The relaxed length L_{R} and the relaxed thickness T_{R} are illustrated in FIG. 6 and extended length L_{E} and extended the thickness T_{E} are illustrated in FIG. 7.
A=T_{E}−T_{R}
The changes in thickness of the elastomer in the relaxed and fully extended state can be considered negligible in the overall thickness of the laminate. Next the average amount of material length (M) that can be used to form the features is determined by L_{E}−L_{R}.
M=L_{E}−L_{R}
The average number of ‘macroscale’ features per unit length (N) that the laminate can have is calculated by dividing the length of material that is gathered by 2 times the amplitude of the features (accounting for the shortest length possible for one complete feature) and the length of the relaxed laminate. In the case of a material being flat and non extendable, M will approach zero and the calculation will yield zero features of infinite spacing. The limit can be determined for the formula where A approaches zero. The number of features will approach an infinite value and their spacing will also approach zero. This yields a flat material. For the purposes of determining parameters, based on the number of features per unit length, materials having a calculated feature density of greater than 100 features per centimeter are considered to have topography on a microscale and considered ‘flat’. As M approaches 0 the limit can be taken for the formula and is shown to be indeterminate. In this instance the material would have one feature of infinite spacing and be considered ‘flat’ for a non-extensible and non-featured surface.
N=M/(2*A*L_{R})
The average spacing of the features can also be estimated by taking the inverse of N.
Spacing (cm)=1/N.
In the case of a material being flat and non extendable, M will approach zero and the calculation will yield zero features of infinite spacing. As M approaches 0 the limit can be taken for the formula and is shown to be indeterminate. In this instance the material would have zero features spaced infinitely far apart. In this case the material will be considered “flat” for a non-extensible and non-featured surface.
The limit can be determined for the formula where A approaches zero. The number of features will approach an infinite value and their spacing will also approach zero, thus yielding a flat material. For the purposes of determining defining “macroscale” features based on the number of features per unit length, materials having a calculated feature density of 100 features per centimeter or more are considered to have topography on a microscale and considered ‘flat’.
Web Oil Permeability

Web permeability is obtained from a measurement of the resistance by the material to the flow of liquid. A liquid of known viscosity is forced through the material of a given thickness at a constant flow rate and the resistance to flow, measured as a pressure drop is monitored. Darcy's Law is used to determine permeability as follows:
Permeability=[flow rate×thickness×viscosity/pressure drop]
Where the units are as follows:

permeability: cm or Darcy (1 Darcy=9.87×10⁻⁹ cm²)

flow rate: cm/sec

viscosity: pascal-sec

pressure drop: pascals

The apparatus includes an arrangement wherein a piston within a cylinder pushes liquid through the sample to be measured. The sample is clamped between two aluminum cylinders with the cylinders oriented vertically. Both cylinders have an outside diameter of 3.5″, an inside diameter of 2.5″ and a length of about 6″. The 3″ diameter web sample is held in place by its outer edges and hence is completely contained within the apparatus. The bottom cylinder has a piston that is capable of moving vertically within the cylinder at a constant velocity and is connected to a pressure transducer that capable of monitoring the pressure encountered by a column of liquid supported by the piston. The transducer is positioned to travel with the piston such that there is no additional pressure measured until the liquid column contacts the sample and is pushed through it. At this point, the additional pressure measured is due to the resistance of the material to liquid flow through to it. The piston is moved by a slide assembly that is driven by a stepper motor.

The test starts by moving the piston at a constant velocity until the liquid is pushed through the sample. The piston is then halted and the baseline pressure is noted. This corrects for sample buoyancy effects. The movement is then resumed for a time adequate to measure the new pressure. The difference between the two pressures is the pressure is due to the resistance of the material to liquid flow and is the pressure drop used in the Equation set forth above. The velocity of the piston is the flow rate. Any liquid whose viscosity is known can be used, although a liquid that wets the material is preferred since this ensures that saturated flow is achieved. The measurements were carried out using a piston velocity of 20 cm/min, mineral oil (Peneteck Technical Mineral Oil manufactured by no Penreco of Los Angeles, Calif.) of a viscosity of 6 centipoise. This method is also described in U.S. Pat. No. 6,197,404 to Varona, et al.

### COMPARATIVE EXAMPLE A

Comparative Example A is an example of a 2-sided Vertical Filament Laminate (VFL) that was formed according to the process generally described in Example 3 of U.S. Patent Application Publication no. 2002/0104608 to Welch et al. the entirety of which is hereby incorporated by reference herein. Specifically, the VFL of Comparative Example A was formed with 11.5 grams per square meter of elastic in the laminate nip during process which corresponds to 8.2 grams per die hole per minute, running at 1100 feet per minute, with a 5.2× stretch ratio and a 50% winder ratio, the denier at the first chill roll is equal to or greater than 1140; the denier at the nip is equal to or greater than 220; and the denier at the winder is equal to or greater than 440. The VFL was not treated with any chemistries to impart wettability to the VFL.

### COMPARATIVE EXAMPLE B

Comparative Example B is an example of 35 percent necked, conventional polypropylene spunbond (SB) liner that was formed according to the process generally described in U.S. Pat. No. 4,965,122 to Morman et al. the entirety of which is hereby incorporated by reference herein. The SB liner was treated with a 0.34 weight percent aqueous treatment solution of AHCOVEL and GLUCOPON combined at a 3:1 ratio.

### EXAMPLE 1

An elastic laminate was formed from one 35 percent necked, 0.6 osy spunbond facing sheet as used in Comparative Example B above and 5 KRATON 2760 elastic strands per inch as generally described and illustrated herein to produce an elastic laminate having 5 elastic topographical strands per inch. This Example 1 provided both CD extensibility and MD stretch. The facing sheet was treated with wettable chemistry prior to being incorporated in the laminate as generally described in U.S. Patent Application Publication No. 2004/0121680 to Yahiaoui et al. Specifically, the facing sheet was surface treated with a 0.34 weight percent, aqueous mixture of AHCOVEL and GLUCOPON combined in a 3:1 ratio prior to lamination of the KRATON 2760 strands onto the necked, spunbond facing sheet.

### EXAMPLE 2

An elastic laminate was formed from one crimped facing sheet and 5 KRATON 2760 elastic strands. The crimped facing sheet was a crimped, lofty nonwoven, spunbonded web having a basis weight of about 0.5 osy, made of side-by-side polyethylene/polypropylene fibers made in accordance with the methods described in U.S. patent application Ser. No. 10/037,467 now U.S. Patent Application Publication no. 2003/0118816. The facing sheet of Example 2 was also treated with wettable chemistry prior to being incorporated in the laminate as described above. Specifically, the facing sheet was surface treated with a 0.34 weight percent, aqueous mixture of AHCOVEL and GLUCOPON combined in a 3:1 ratio prior to lamination of the KRATON 2760 strands onto the necked, spunbond facing sheet.

### EXAMPLE 3

An elastic laminate was formed from one 35 percent necked, 0.6 osy spunbond facing sheet and KRATON 2760 strands as described in Example 1 above except 0.05 osy of BOSTICK FINDLEY 2717 adhesive was applied to the spunbond facing sheet by a melt spray before the strands were contacted to the facing sheet. The facing sheet of Example 3 was also treated with wettable chemistry prior to being incorporated in the laminate as described above. Specifically, the facing sheet was surface treated with a 0.34 weight percent, aqueous mixture of AHCOVEL and GLUCOPON combined in a 3:1 ratio prior to lamination of the KRATON 2760 strands onto the necked, spunbond facing sheet.

### EXAMPLE 4

An elastic laminate was formed from one 35 percent necked, 0.6 osy spunbond facing sheet and KRATON 2760 strands as described in Example 1 above except 0.05 osy of BOSTICK FINDLEY 9331 adhesive was applied to the spunbond facing sheet by a melt spray before the strands were contacted to the facing sheet. The facing sheet of Example 4 was also treated with wettable chemistry prior to being incorporated in the laminate as described above. Specifically, the facing sheet was surface treated with a 0.34 weight percent, aqueous mixture of AHCOVEL and GLUCOPON combined in a 3:1 ratio prior to lamination of the KRATON 2760 strands onto the necked, spunbond facing sheet.

Examples 2 and 3 and Comparative Examples A and B were measured for Fecal Fluid Intake using LVA1 Fecal Fluid Simulant and test procedure described above. The results are presented in Table 1 below. As can be seen from the data presented in Table 1, the present invention provided an improved liquid permeable facing having topographical features that has a Fecal Fluid Intake rate of greater than 0.5 milliliters per second using the Fecal Fluid Intake Test using LVA1 Fecal Fluid Simulant, greater than 0.6 ml/sec, greater than 0.7 ml/sec, greater than 1 ml/sec, and even greater than 1.5 ml/sec (see Example 2 at 1.8 ml/sec) in the relaxed position. In Table 1, a “-” designation indicates a test not performed for that material or at that extension level.

TABLE 1
PERMEABILITY AND BM INTAKE TEST RESULTS

| | | | LVA1 Fecal | | LVA1 Fecal | | LVA1 Fecal | |
|---|---|---|---|---|---|---|---|---|
| | | | Fluid intake | | Fluid intake | | Fluid intake | |
| | Oil | Air | rate in | | rate at 25% | | rate at 100% | |
| Example | permeability | permeability | relaxed | | extension of | | extension of | |
| no. | (Darcy) | (cfm) | position | | laminate | | laminate | |
| A | 373 | 289 | <0.2 | ml/sec | <0.2 | ml/sec | <0.2 | ml/sec |
| 2 | 3127 | 945 | 1.8 | ml/sec | 1.8 | ml/sec | 1.2 | ml/sec |

| | | | | | | |
|---|---|---|---|---|---|---|
| 3 | 3934 | 1090 | 0.75 | ml/sec | — | — |
| B | — | — | 0.75 | ml/sec | — | — |

Examples 1 and 3 and Comparative Example A were measured for mechanical properties using cyclic testing. The test results are presented in Table 2 below. As can be seen in Table 2, Examples 1 and 3 of the present invention are more pliable and require less force to elongate while still retaining elastic properties and low amounts of permanent deformation than a conventional 2-face elastic material that is used for other non-permeable components of a diaper (Comparative A).

TABLE 2
CYCLE TESTING RESULTS

| | Load (gf) | Load (gf) | Load (gf) | 2^{nd} cycle | |
|---|---|---|---|---|---|
| Example | at 20% | at 40% | at 100% | immediate | 2^{nd} cycle |
| no. | elongation | elongation | elongation | set | hysteresis |
| A | 265 | 402 | 455 | 7% | 20% |
| 1 | 116 | 207 | 256 | 14% | 40% |
| 3 | 84 | 158 | 193 | 15% | 39% |

Examples 1 and 3 and Comparative Examples A and B were measured for topographical features. The measurement results are presented in Table 3 below. As can be seen in Table 3, Examples 1 and 3 of the present invention provide macroscopic features that differ in number and spacing than features that may be measured on other materials (Comparative Examples A and B).

TABLE 3
MACROSCALE FEATURE TESTING RESULTS

| | N | | |
|---|---|---|---|
| | (Maximum features/cm | | Amplitude |
| Example no. | in the CD direction) | Spacing (mm) | (mm) |
| A | 40 | 0.25 | 0.7 |
| 1 | 7.5 | 1.32 | 1.0 |
| 3 | 8 | 1.26 | 0.9 |
| B | 0 | ∞ | 0 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A liquid permeable facing material comprising an elastic strand laminate, comprising a laminate that comprises:
at least one facing sheet having an exterior surface upon which are disposed
a plurality of strands of an elastomeric composition that form features in the laminate in the relaxed state having a height that exceeds the thickness of the facing sheet of at least about 0.8 millimeter.

2. The liquid permeable facing material of claim 1, wherein the plurality of strands is spaced apart on the at least one facing sheet by 1 to 40 strands per centimeter.

3. The liquid permeable facing material of claim 1, wherein each of the plurality of strands has a diameter of at least about 0.2 millimeters.

4. The liquid permeable facing material of claim 1, wherein the at least one facing sheet comprises a nonwoven web selected from the group consisting of necked spunbond webs and crimped spunbond webs.

5. The liquid permeable facing material of claim 1, wherein the plurality of strands are spaced apart on the at least one facing sheet by 5 to 30 strands per centimeter.

6. The liquid permeable facing material of claim 6, wherein the plurality of strands are spaced apart on the at least one facing sheet by 5 to 25 strands per centimeter.

7. The liquid permeable facing material of claim 1, wherein the plurality of strands are spaced apart on the at least one facing sheet by 5 to 10 strands per centimeter.

8. The liquid permeable facing material of claim 1, wherein the features of the laminate have an average height of at least 0.9 millimeters greater than the thickness of the facing sheet.

9. The liquid permeable facing material of claim 9, wherein the features of the laminate have an average height of at least 1 millimeter greater than the thickness of the facing sheet.

10. The liquid permeable facing material of claim 1, wherein the average spacing between features ranges from about 0.5 millimeters to about 5 millimeters.

11. The liquid permeable facing material of claim 1, wherein the average spacing between features ranges from about 0.5 millimeters to about 3 millimeters.

12. The liquid permeable facing material of claim 1, wherein the laminate has a basis weight between about 25 and about 110 grams per square meter.

13. The liquid permeable facing material of claim 1, wherein the facing material is extensible in the CD direction and can stretch by at least about 10 percent in the machine direction.

14. The liquid permeable facing material of claim 1, wherein the facing material is extensible in the CD direction and can stretch by at least about 25 percent in the machine direction.

15. The liquid permeable facing material of claim 1, wherein the facing material is extensible in the CD direction and can stretch by at least about 50 percent in the machine direction.

16. The liquid permeable facing material of claim 1, wherein the facing material has a Fecal Fluid Intake rate of greater than 0.5 milliliters per second using the Fecal Fluid Intake Test and LVA1 Fecal Fluid Simulant.

17. The liquid permeable facing material of claim 1, wherein the facing material has a Fecal Fluid Intake rate of greater than 0.6 milliliters per second using the Fecal Fluid Intake Test using LVA1 Fecal Fluid Simulant.

18. The liquid permeable facing material of claim 1, wherein the facing material has a Fecal Fluid Intake rate of greater than 0.7 milliliters per second using the Fecal Fluid Intake Test using LVA1 Fecal Fluid Simulant.

19. The liquid permeable facing material of claim 1, wherein the facing material has a Fecal Fluid Intake rate of greater than 0.8 milliliters per second using the Fecal Fluid Intake Test using LVA1 Fecal Fluid Simulant.

20. The liquid permeable facing material of claim 1, wherein the facing material has a Fecal Fluid Intake rate of greater than 0.9 milliliters per second using the Fecal Fluid Intake Test using LVA1 Fecal Fluid Simulant.

21. The liquid permeable facing material of claim 1, wherein the plurality of elastic strands provide elasticity in both the cross direction and the machine direction.
